(19) United States
(12) Patent Application Publication
(10) Pub. No.: US 2024/0160396 A1
(43) Pub. Date: May 16, 2024

(54) WIRELESS DISPLAY FOR HEADSET

(71) Applicant: RealWear, Inc., Vancouver, WA (US)

(72) Inventors: James Peter Woodall, Helmond (NL); Noah Nicholas Balmer, Vancouver, WA (US); Christopher Parkinson, Richland, WA (US)

(21) Appl. No.: 18/055,369

(22) Filed: Nov. 14, 2022

(51) Int. Cl. G06F 3/14; G06F 1/16; H04N 5/225; H04N 7/18

(52) U.S. Cl. CPC G06F 3/14; G06F 1/163; H04N 5/2257; H04N 7/183

(57) ABSTRACT

Embodiments of the present disclosure are generally directed to a head-mounted base system that allows a user to remove a display portion from a base portion thereof. According to some examples, the user captures video data via a head-mounted display (HMD) or other head mounted computing device. This head mounted computing device comprises a wearable system which allows the user to perform tasks and capture video data by the HMD simultaneously. It is desired that the user or technician be able to view video data provided to the HMD hands-free. The user may be able to attach an auxiliary display system which self-aligns with the head-mounted base system. When the auxiliary display system attaches to the head-mounted base system, a wireless connection capable of transmitting video is established allowing the user to attach and remove the auxiliary display system easily and without disrupting a video recording device.

### CROSS REFERENCE TO RELATED APPLICATIONS

This application is related by subject matter to commonly-assigned and concurrently-filed application: Attorney docket number 40962.386433, titled “WEARABLE MEDIA STREAMING SYSTEM”, filed Nov. 14, 2022, the same date as the present application, which is hereby expressly incorporated by reference in its entirety.

### BACKGROUND

Digital video camera and display devices are utilized in a variety of use cases. Consumers and businesses alike utilize video camera devices to capture video content in live action scenarios. In some cases, video content can be live streamed to remote client devices, provided that network connectivity is readily accessible.

### SUMMARY

This summary is provided to introduce a selection of concepts in a simplified form that are further described below in the detailed description. This summary is neither intended to identify key or essential features of the claimed subject matter, nor is it intended to be used as an aid in determining the scope of the claimed subject matter.

In contrast to conventional systems, embodiments of the present disclosure are generally directed to a head-mounted system that allows a user to remove a display portion from a base portion thereof. According to some examples, the user captures video data via a head-mounted display (HMD) or other head mounted computing device. This head mounted computing device comprises a wearable system which allows the user to perform tasks and capture video data by the HMD simultaneously. It is desired that the user or technician be able to view the video data provided to the HMD hands-free. The user may be able to attach an auxiliary display device which self-aligns with the base portion. When the auxiliary display device attaches to the base portion, a wireless connection capable of transmitting video is established allowing the user to attach and remove the auxiliary display device easily and without disrupting the video capturing.

### BRIEF DESCRIPTION OF THE DRAWINGS

The present disclosure is described in detail below with reference to the attached figures, wherein:

FIG. 1 is an exemplary head-mounted base system in accordance with an embodiment of the present disclosure;

FIG. 2 is an exemplary head-mounted base system in accordance with an embodiment of the present disclosure;

FIG. 3 is an exemplary auxiliary display system in accordance with an embodiment of the present disclosure;

FIG. 4 is an exemplary auxiliary display system in accordance with an embodiment of the present disclosure;

FIG. 5 is an exemplary auxiliary display system in accordance with an embodiment of the present disclosure;

FIG. 6 is an exemplary head-mounted display system in accordance with an embodiment of the present disclosure;

FIG. 7 a schematic depiction is provided illustrating an exemplary system 700 in which some embodiments of the present disclosure may be employed; and

FIG. 8 is an exemplary operating environment in accordance with an embodiment of the present disclosure.

### DETAILED DESCRIPTION

The subject matter of the present disclosure is described with specificity herein to meet statutory requirements. However, the description itself is not intended to limit the scope of the present disclosure. Rather, the inventors have contemplated that the claimed subject matter might also be embodied in other ways, to include different steps or combinations of steps similar to the ones described in the present disclosure, in conjunction with other present or future technologies. Moreover, although the terms “step” and/or “block” may be used herein to connote different elements of methods employed, the terms should not be interpreted as implying any particular order among or between various steps disclosed herein unless and except when the order of individual steps is explicitly described.

As digital camera technology has advanced in recent years, the number of camera devices capable of recording and/or streaming live video over the Internet has expanded a great deal. These camera devices, however, generally incorporate carrier service technology (for example, 5G services) that enables the camera devices to communicate directly with a telecommunications company or Internet service provider. Such devices are oftentimes sold as or incorporated into smartphones or tablets with cellular services. While these handheld devices are ubiquitous, users oftentimes find the handheld devices to be impractical as a communications means or as a reference tool, particularly when the handheld devices are performing tasks that require use of their hands. To address such concerns, among many others, RealWear, Inc. developed a wearable, hands-free communications, and software services solution, otherwise known as the HMT-1®. The HMT-1® incorporates cutting-edge technologies that facilitate live video communications for remote expert viewing and guidance, digital workflow solutions, document retrieval and navigation, industrial Internet of Things (IoT) data visualization, and high-resolution photo capture, among many other things. The HMT-1© is a wearable computing device that is suitable for use in various industrial settings, as it is fully encapsulated and built rugged. While the HMT-1® has demonstrated a great deal of commercial success, RealWear has learned that many of their users are typically carrying a carrier device (for example, a smartphone or tablet with cellular connectivity) while wearing the HMT-1©. To reduce the weight and footprint of a wearable computing device that is capable of providing many features of the HMT-1®, RealWear Inc. has developed various solutions described herein to harness the resources (for example, Internet connectivity, processing power) of a user's carrier device, to provide the same features and services of the HMT-1© in a low profile and lightweight wearable camera and display accessory for the user's carrier device.

Embodiments of the present disclosure are directed to a modular head-mounted base system (alternatively referred to as “head-mounted base” in the present disclosure) which comprises several components. A rear frame portion and one or more side frame portions are used to make up the modular head-mounted base system. The one or more side frame portions and the rear frame portion comprises a continuous component which houses electrical, computational, and video components that allow the user to record video from a camera. The one or more side frame portions also contain a power port module that connects to an auxiliary display device and provides power to the auxiliary display device. One or more alignment components are added to the one or more side frame portions that are comprised of magnets, and that allow for the securing and alignment of the auxiliary display device to the modular head-mounted base system.

In some embodiments, an auxiliary display system (alternatively referred to as “modular auxiliary display system” in the present disclosure) is provided which is detachable from the modular head-mounted base system described previously. The auxiliary display system comprises a lens frame portion, one or more arm frame portions, and a display module. The one or more arm frame portions contain an auxiliary power port module which receives power from a power port of the modular head-mounted base system. The one or more arm frame portions also contain one or more alignment portions that facilitate the alignment and securement of the auxiliary display system to the modular head-mounted base system. The one or more arm frame portions also house a module adapted to be communicatively connected to the modular head-mounted base system when the auxiliary display system is releasably attached to the modular head-mounted base system.

In another embodiment, a head-mounted display system is provided that comprises a modular auxiliary display system and a modular head-mounted base system. The modular auxiliary display system comprises a lens frame portion, one or more arm frame portions, and a display module. The one or more arm frame portions contain an auxiliary power port module which receives power from a power port of the modular head-mounted base system. The one or more arm frame portions also contain one or more alignment portions that facilitate the alignment and securement of the modular auxiliary display system to the modular head-mounted base system. The one or more arm frame portions also house an auxiliary module adapted to be communicatively connected to the modular head-mounted base system when the modular auxiliary display system is releasably attached to the modular head-mounted base system. The modular head-mounted base system comprises several components. A rear frame portion and one or more side frame portions are used to make up the modular head-mounted base system. The one or more side frame portions and the rear frame portion comprises a continuous component which houses electrical, computational, and video components that allow the user to record video from a camera. The one or more side frame portions also contain a power port module that connects to the modular auxiliary display system and provides power to the modular auxiliary display modular. One or more alignment components are added to the one or more side frame portions that are comprised of magnets that allow for the securing and alignment of the modular auxiliary display system to the modular head-mounted base system.

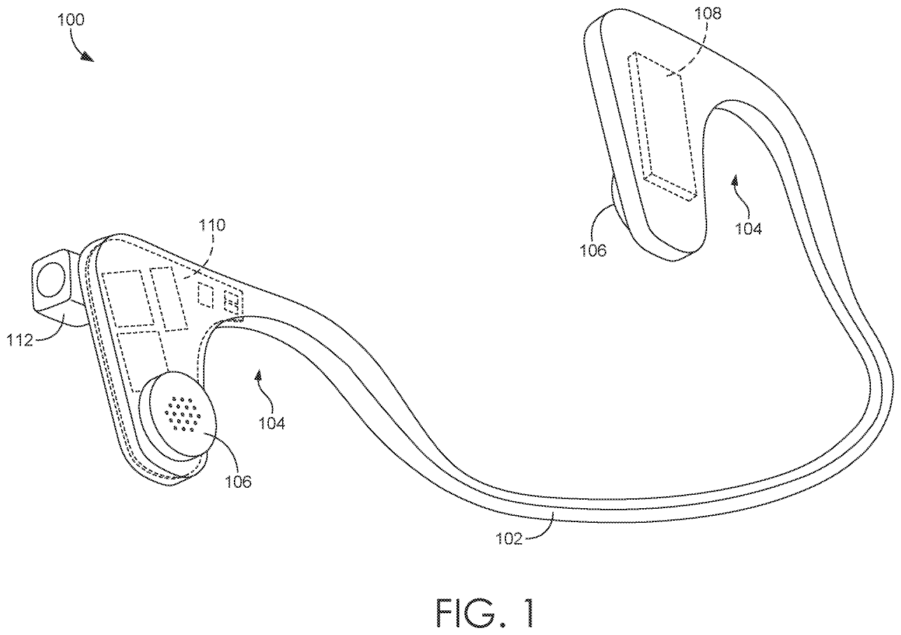

Referring initially to FIG. 1, an exemplary head-mounted base system 100 is provided, in accordance with an embodiment of the present disclosure. The head-mounted base system 100 (alternatively referred to as “the modular head-mounted base system” in the present disclosure) includes a rear frame portion 102, a set of side frame portions 104, one or more speakers 106 coupled to the set of side frame portions 104, a battery module 108, an electronics module 110, and a camera module 112 mounted on the head-mounted base system 100. Although in FIG. 1, the head-mounted base system 100 is illustrated as a continuous frame which goes around a back of a user's head, the head-mounted base system 100 may be configured as other types of headwear as well.

The electronics module 110 provides a consolidation of one or more components of the head-mounted base system 100 (for example, computer processor(s), memory, position-tracking component(s), communication component(s), etc.). However, it should be noted that the components associated with the electronics module 110 may also be distributed at other locations about the head-mounted base system 100 and communicatively connected to each other as necessary, rather than consolidated as shown in FIG. 1. The electronics module 110 provides components to receive and communicate information to an auxiliary device, such as a display device. The components associated with such communication may be any wired electronics that may be able to communicate information. Additionally, the communication may be done via wireless technology, such as wireless high definition multimedia interface (HDMI). Thus, the electronics module 110 may contain a wireless HDMI transmitter and components which establish connection to the auxiliary device when within a desired range. For example, when the auxiliary device is within a particular distance to the heat-mounted base system 100, the wireless HDMI transmitter and components within the electronics module 110 will establish a wireless communication with the auxiliary device. This may also be done when the auxiliary device is connected to a power system of the head-mounted base system 100.

In one embodiment, the rear frame portion 102 is coupled to each of the side frame portions 104 in a continuous fashion. The rear frame portion 102 and the side frame portions 104 are a single continuous piece of material that may be hollow or have portions which are molded such that other components may be attached thereon. In other embodiments, the rear frame portion 102 and the side frame portions 104 are removably coupled. The side frame portions 104 include portions that are shaped or molded so as to rest on a user's ear. The side frame portions 104 may partially enclose the user's ear wherein a front portion of the side frame portions 104 extend down where the one or more speakers 106 may be attached.

The one or more speakers 106 are secured to the side frame portions 104 at a lower portion of the side frame portions 104. The one or more speakers 106 may be externally attached to the side frame portions 104. In another embodiment, the one or more speakers 106 are secured within an internal cavity of the side frame portions 104. The battery module 108 is connected to the electronics module 110 to provide power to circuits of the head-mounted base system 100. The electronics module 110 includes a power distribution circuitry for providing power to the head-mounted base system 100 and also contains a battery charging circuitry to manage recharging the battery module 108. The electronics module 110 includes a battery monitoring circuit that is operable to provide a status of one or more battery status indicators, such as remaining capacity, temperature, voltage, electrical current consumption, and the like, to various components of the head-mounted base system 100, as well as to any peripheral devices connected to the head-mounted base system 100. The head-mounted base system 100 further has the camera module 112 attached either removable or non-removable from one of the side frame portions 104.

Any of the components of the head-mounted base system 100 may be communicatively interconnected with each other. To this effect, communication between components may be provided using a wireless connection (for example, Bluetooth) and/or a wired connection, which may extend through any part of the head-mounted base system 100 as needed to reach different components. The head-mounted base system 100 may also be configured for wireless communication over a network, such as a cellular, Wi-Fi, Bluetooth, and/or satellite network, as well as any other wireless communication modality, using a communication component that is communicatively connected to computer processors associated with the head-mounted base system 100. The communication component (for example, which may include a radio and an antenna) may also be configured to provide, in conjunction with a position-tracking component, location-tracking ability for the head-mounted base system 100 through signal triangulation, a global positioning system (GPS) signal, or another tracking method. Additionally, each of the components of the head-mounted base system 100 requiring power may be connected to the power system through one or more power cables extending through the various components of the head-mounted base system 100.

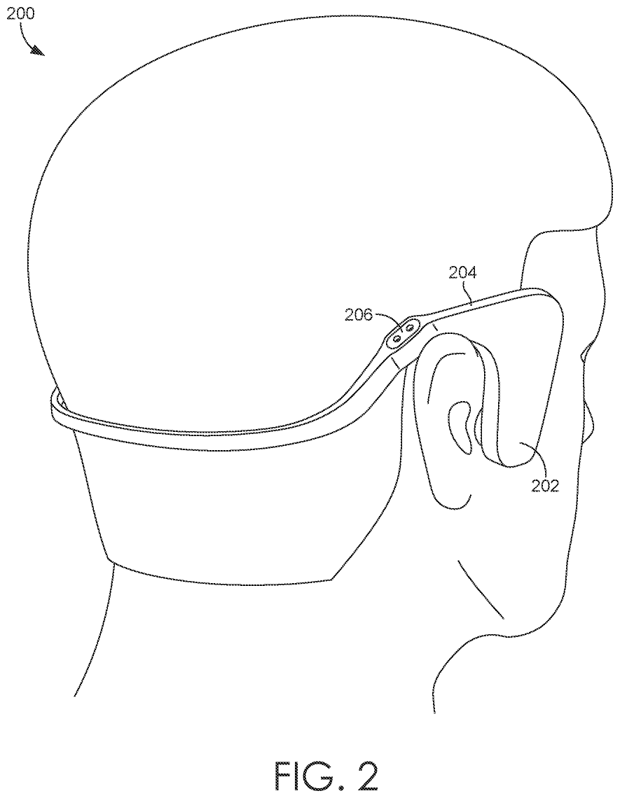

Referring now to FIG. 2, an exemplary head-mounted base system 200 is provided, in accordance with an embodiment of the present disclosure. The head-mounted base system 200 includes all components shown in FIG. 1. The head-mounted base system 200 includes a side frame portion 202, a power port 206, and an alignment portion 204. In one embodiment, the side frame portion 202 is substantially similar to the side frame portions 104 described with respect to FIG. 1. In another embodiment, the side frame portion 202 contains an electronics module (not shown) which has a battery module (not shown), which are substantially similar to the electronics module 110 and the battery module 108, respectively, described with respect to FIG. 1.

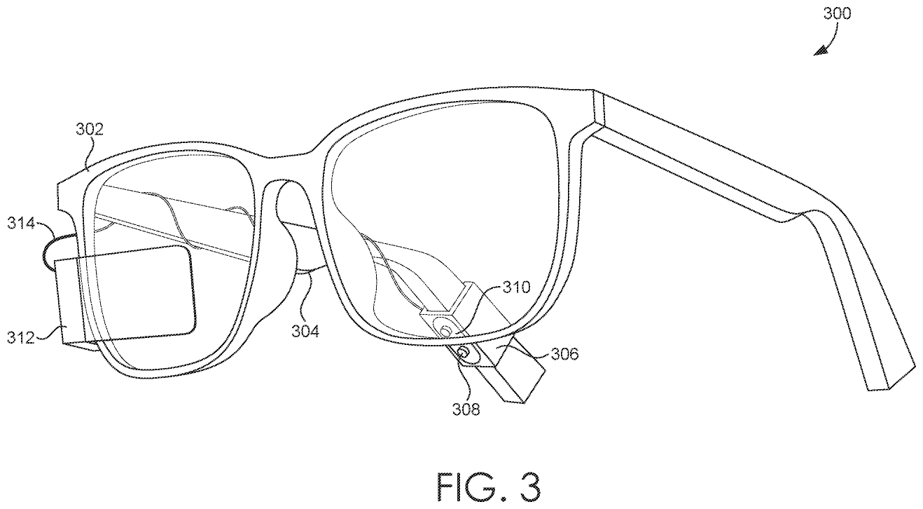

The battery module (not shown in FIG. 2) is connected to the power port 206 so as to provide power to an axillary device, such as an auxiliary device described with respect to FIG. 3. The electronics module includes a power distribution circuitry for providing power to the head-mounted base system 200. The battery module is connected to the electronics module that combined provide power to the power port 206. The electronics module includes a power distribution circuitry for providing power to the power port 206. The electronics module includes a power monitoring circuit that is operable to provide a status of one or more auxiliary devices connected to the power port 206, such as temperature, voltage, electrical current consumption, and the like, to various components of any peripheral devices connected to the head-mounted base system 200. The power port 206 is configured to receive pins, attachment components, or any other conductive components from the auxiliary device. The power port 206 is also configured to transmit information from the auxiliary device, such as device status, device health, connectivity. The power port 206 may also signal to wireless components within the electronics module that the auxiliary device is connected and that it should establish a wireless connection with the auxiliary device.

The alignment portion 204 is configured to align and secure the auxiliary device to the head-mounted base system 200. The alignment portion 204 is a part of the side frame portion 202 and contains elements which align the auxiliary device with respect to the head-mounted base system 200 and secures the auxiliary device to the head-mounted base system 200. In one embodiment, the alignment portion 204 is a magnet secured to or within the side frame portion 202. An additional magnet is secured to the auxiliary device, such that, when the auxiliary device is brought close, the magnets attract each other aligning the auxiliary device to the head-mounted base system 200 and securing the auxiliary device in a desired position.

Referring to FIG. 3, an exemplary auxiliary display system 300 is provided, in accordance with an embodiment of the present disclosure. The auxiliary display system 300 (alternatively referred to as “modular auxiliary display system” in the present disclosure) includes a lens frame 302, a frame arm 304 (alternatively referred to as “arm frame portions” in the present disclosure), an auxiliary power port 306, auxiliary power pins 308, a communication module 310, a display module 312, and a communication cable 314. The lens frame 302 may be a frame structure. As shown in FIG. 3, the lens frame 302 is configured and arranged for wearing by a user. The lens frame 302 is also configured to house an optical lens for eye protection and optical correction. For instance, the lens frame 302 is configured to be coupled to the frame arm 304 and may be worn about the user's head.

In one embodiment, the frame arm 304 is configured to house the auxiliary power port 306. The auxiliary power port 306 is configured to be positioned on the frame arm 304 such that, when the frame arm 304 is positioned adjacent the head-mounted base system 200 or 100, the auxiliary power pins 308 align with the power port 206 (see FIG. 2). The auxiliary power pins 308 are comprised of conductive pins or pads such that power and/or information may be passed through and from the head-mounted base system 200 to the auxiliary display system 300. Additionally, the display module 312 is configured to be connected to the communication module 310 by way of the communication cable 314. The frame arm 304 is also configured to house an alignment magnet in a bottom or a lower portion which may be adjacent the head-mounted base system 200 or 100 when the auxiliary display system 300 and the head-mounted base system 200 or 100 are coupled together.

The communication module 310 is configured to establish a communication channel from the auxiliary display system 300 to the head-mounted base system 100 or 200. The communication channel to be established may either be wired or wireless. A wired communication channel may be established using a wired USB or HDMI cable from the communication module 310 to the head-mounted base system 200 (see FIG. 2). In another embodiment, the communication channel configuration includes two-way wireless communication functions. The communication module 310 incorporates communication subsystem elements, such as a wireless transmitter, a wireless receiver, and associated components such as one or more antenna elements. A digital signal processor (DSP) performs processing to extract data from received wireless signals and to generate signals to be transmitted. A particular design of the communication subsystem elements is dependent upon a communication network and associated wireless communication protocols with which the device is intended to operate. In another embodiment, the associated wireless communication protocols and associated hardware are used to establish a wireless HDMI connection. Additional wireless connections may be considered such that a video feed may be communicated between the auxiliary display system 300 and the head-mounted base system 200 or 100.

The communication module 310 is configured to transmit/receive or communicate communication media to and from the head-mounted base system 100 or 200. The communication media typically embodies computer-readable instructions, data structures, program modules or other data in a modulated data signal, such as a carrier wave or other transport mechanism, and includes any information delivery media. The term “modulated data signal” refers to a signal that has one or more of its characteristics set or changed in a manner to encode information in the signal. By way of non-limiting example, the communication media includes wired media, such as a wired network or direct-wired connection, and wireless media, such as acoustic, RF, infrared and another wireless media. Combinations of any of the above should also be included within the scope of computer-readable media. The communication media includes instructions for the display module 312.

The display module 312 houses a display device that is directed towards the eyes of the user. As used in the present disclosure, the display module 312 includes any component used with a head-mounted display that is configured to provide a display characteristic that is viewable to a user. The term “display characteristic” includes any viewable characteristic, such as a display state (for example, transparent, partially transparent, non-transparent, selectively transparent, interactive, text/image/video presenting, etc.), a display type (for example, an optic, waveguide optic, digital display, micro display (for example, a liquid crystal display (LCD), light-emitting diode (LED) display, organic light-emitting diode (OLED) display, digital light processing (DLP) display, etc.), or any combination thereof, etc.), a display configuration (for example, one or multiple display portions of the same or different type, display portions at different angles, display portions in different arrangements, etc.), and/or technical specifications of the display portion (for example, resolution, pixels per inch, size, parallax, contrast, color depth, refresh rate, etc.), in addition to other display characteristics. The preceding examples are intended to be exemplary and non-limiting.

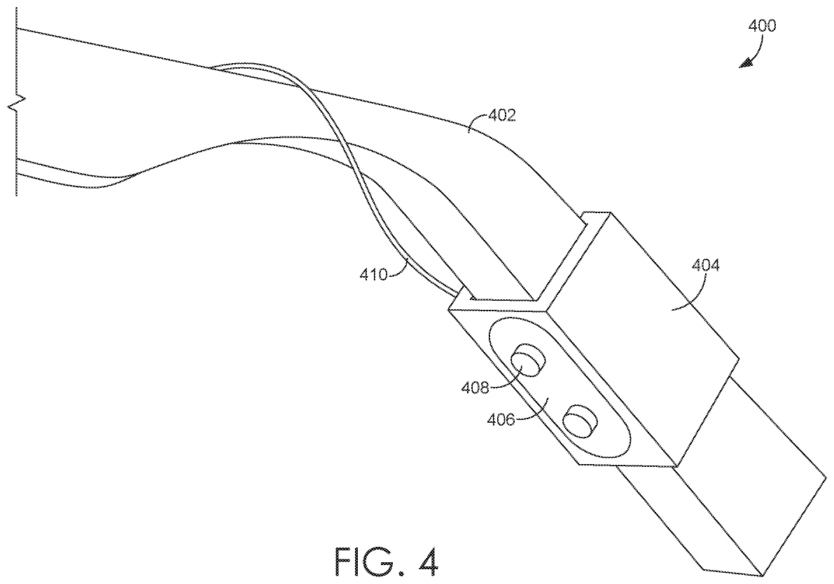

As can be seen in FIG. 4, an example of a close up view of an auxiliary display system 400 is provided, in accordance with an embodiment of the present disclosure. The auxiliary display system 400 includes a frame arm 402, an auxiliary power port 404, auxiliary power pin 408, a communication module 406, and a communication cable 410. The frame arm 402 may be a frame structure. As shown in FIG. 4, the auxiliary power port 404 includes at least two auxiliary power pins 408 configured to directly connect or align with the power port 206 of the head-mounted base system 200 (see FIG. 2). The alignment is aided by alignment magnets included in the frame arm 402. The alignment magnets may be positioned at any position within the frame arm 402 such that the alignment magnets align with the magnet found within the side frame portion 202 (see FIG. 2) of the head-mounted base system 200. In one embodiment, the alignment magnets found within the frame arm 402 are adjustable in position such that, when the head-mounted bases system 200 and the auxiliary display system 400 are adjacent, the position, when secured together by the alignment magnets, is adjustable.

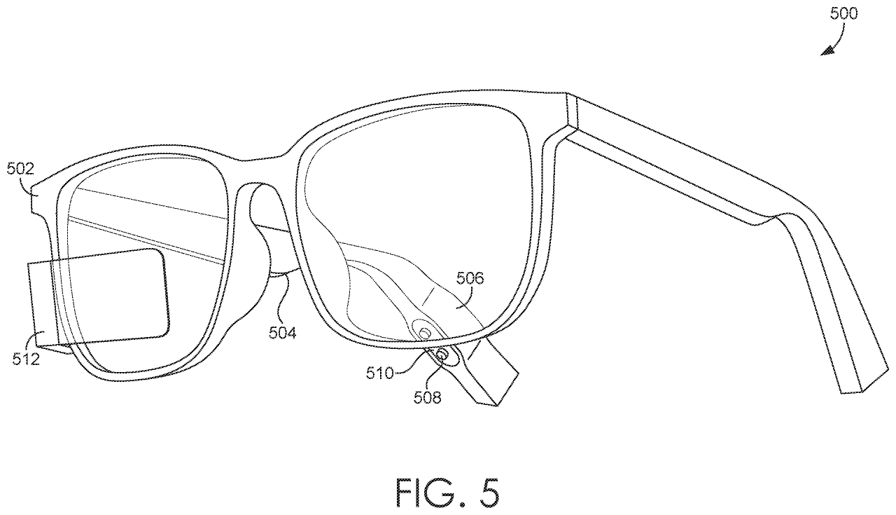

Referring to FIG. 5, an exemplary auxiliary display system 500 is provided, in accordance with an embodiment of the present disclosure. The auxiliary display system 500 includes a lens frame 502, a frame arm 504, an auxiliary power port 506, auxiliary power pins 508, a communication module 510, and a display module 512. In one embodiment, the display module 512 may be connected to the communication module 510 by way of a wireless communication network. The communication module 510 may also be configured to be connected via a wired connection that is housed within the frame arm 504.

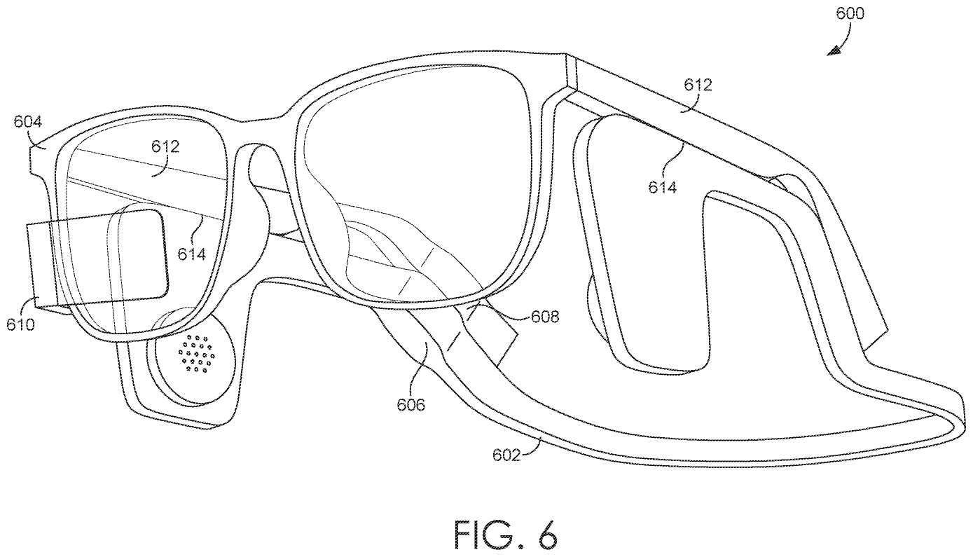

Referring to FIG. 6, an exemplary display system 600 is provided, in accordance with an embodiment of the present disclosure. The display system 600 includes a head-mounted base system 602, an auxiliary display system 604, a base power port module 606, an auxiliary power port module 608, a display module 610, frame arms 612, and alignment portions 614. As shown in FIG. 6, the alignment portions 614 comprise a base alignment portion as described with respect to FIG. 2 and an auxiliary alignment portion as described with respect to FIG. 3 and FIG. 4.

The embodiment shown in FIG. 6 depicts a mating of the head-mounted base system 602 and the auxiliary display system 604. The alignment portions 614 are used to align the head-mounted base system 602 and the auxiliary display system 604 and keep them mated in a secured fashion. To accomplish this, the alignment portions 614 have at least one magnet in each of an alignment portion of the head-mounted base system 602 and the alignment portions 614 of the auxiliary display system 604. For example, the head-mounted base system 602 may have an alignment portion which contains a magnet held within the frame arm (such as the frame arm 304 of FIG. 3) thereof. Additionally, the auxiliary display system 604 has a magnet held within the frame arms 612 thereof. When the alignment portion of the head-mounted base system 602 and the alignment portion 614 of the auxiliary display system 604 come into each other's magnetic field, the magnets attract each other in such a way to align themselves in a predictable fashion. The alignment portions 614 is also used to mate the head-mounted base system 602 and the auxiliary display system 604 in the secured fashion.

In an additional embodiment shown in FIG. 6, the mating of the head-mounted base system 602 and the auxiliary display system 604 is depicted. In one example, the base power port module 606 (described in more detail and referred to as the “power port 206” in FIG. 2) and the auxiliary power port module 608 (referred to as the auxiliary power port 306 and described in more detail in FIG. 3, referred to as the auxiliary power port 404 and described in more detail in FIG. 4) are joined or mated. Once joined, electrical power is allowed to flow from the head-mounted base system 602 to the auxiliary display system 604. The mating of the power ports allows for the display module 610 to receive power from the electronics module 110 of FIG. 1. Additionally, the base power port module 606 and the auxiliary power port module 608 may each house components associated with the communication module 310 of FIG. 3. By joining the base power port module 606 and the auxiliary power port module 608, the communication module 310 may establish either a wired or a wireless communication between the head-mounted base system 602 and the auxiliary display system 604.

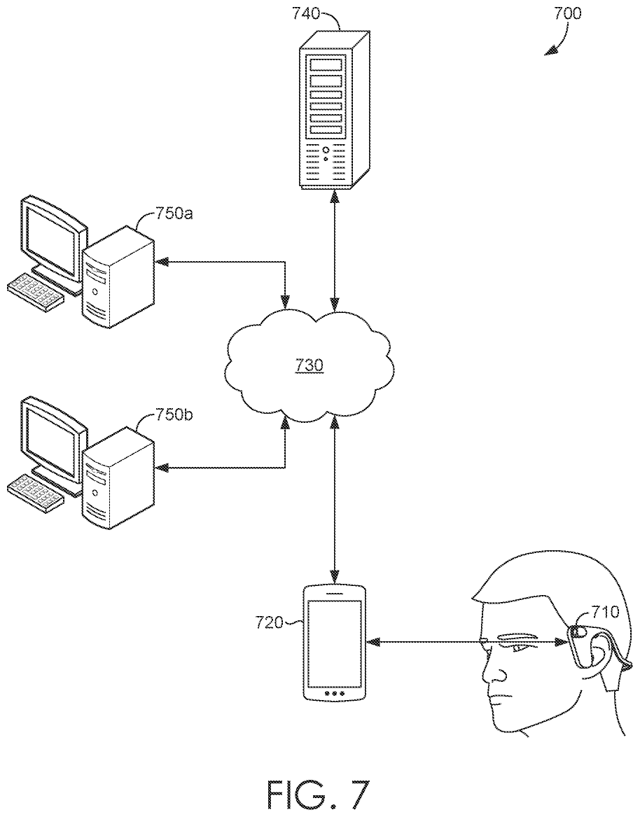

Turning now to FIG. 7, a schematic depiction is provided illustrating an exemplary system 700 in which some embodiments of the present disclosure may be employed. It should be understood that this and other arrangements described herein are set forth only as examples. Other arrangements and elements (for example, machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in a memory.

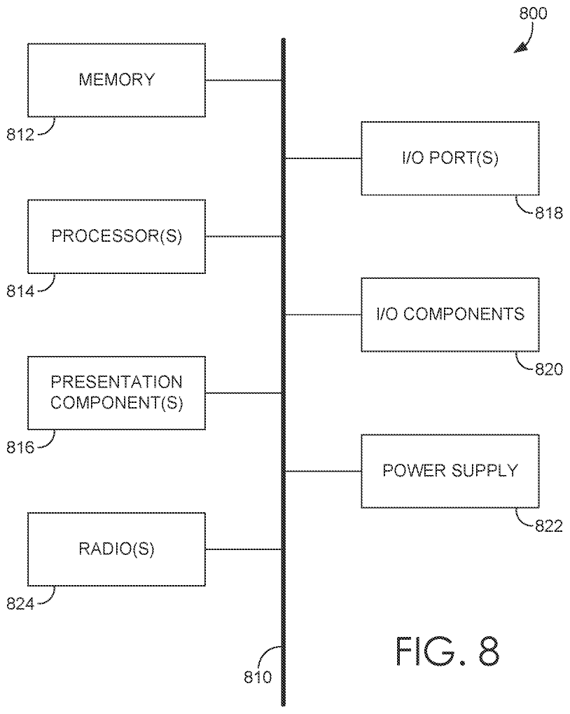

The system 700 includes a media capturing device 710, preferably a wearable camera accessory that is communicably coupled with a mobile computing device 720. The media capturing device 710 can include any number of media input modules, such as a video capturing module (for example, a camera), an audio capturing module (for example, a microphone), any other light sensing (for example, infrared sensor) or emitting (for example, LED, laser) module, or any combination thereof. The media capturing device 710 can include one or more wireless communication modules, such as a Bluetooth module, a Wi-Fi module, or any other short or long range wireless communication module that facilitates communication between the media capturing device 710 and one or more computing devices, such as a computing device 800 described with reference to FIG. 8.

The mobile computing device 720 can include any computing device, such the computing device 800 of FIG. 8. The mobile computing device 720 can be in the form of a smart phone, a tablet, a laptop, a gaming device, or the like, though a portable form-factor is preferred. The mobile computing device 720 can include one or more wireless communication modules for short-range communication (for example, Bluetooth), long-range communication (for example, Wi-Fi), and carrier service communications (for example, LTE, 3G, 4G, 5G), among other things. The carrier service communications facilitate Wide Area Network (for example, Internet) connectivity from the mobile computing device 720. In some embodiments, the mobile computing device 720 includes a wireless hotspot that activates a Wi-Fi access point within the mobile computing device 720, so that other computing devices within a transmissible range of a Wi-Fi access point can connect thereto and utilize a network 730 (for example, Internet) connectivity of the mobile computing device 720.

In a preferred embodiment, the media capturing device 710 is a lightweight head-worn device that can be worn around a user's head, and depicted as a wearable camera device 710 in FIG. 7. It is contemplated, however, that the media capturing device 710 could also be clipped to or coupled to an article of a user's clothing, a headwear, luggage, a grip, a monopod, a tripod, or the like. To this end, for purposes of the present disclosure and merely for use as a non-limiting reference, the media capturing device 710 will also be referred to herein as a “headset” as a result of the representative illustration in FIG. 7.

In some embodiments, the media capturing device 710 can receive long-range wireless (for example, Wi-Fi) pairing information from the mobile computing device 720. In a preferred embodiment, the pairing information (for example, WPA, WPA2, WPA3, WEP, TKIP, or Wi-Fi access credentials generally) is associated with a Wi-Fi hotspot service of the mobile computing device 720, though it is contemplated that the pairing information may be associated with another Wi-Fi hotspot or an access point within a range of the mobile computing device 720 and/or the media capturing device 710.

In some embodiments, the media capturing device 710 can obtain the pairing information from the mobile computing device 720 by scanning a code (for example, QR code, bar code) or text displayed on a screen of the mobile computing device 720. It is contemplated that either upon turning on the media capturing device 710 or in response to predefined set of button presses on the media capturing device 710, the media capturing device 710 can enter a scanning mode to activate a camera thereof, scan a display of the mobile computing device 720 positioned in front of the camera, decode a code or text on the display to obtain the pairing information, and utilize the obtained pairing information to connect to the Wi-Fi hotspot service or access point. It is contemplated that an application of the mobile computing device 720, such as one that may be associated with the media capturing device 710, can facilitate generation of the code, activate and/or deactivate the Wi-Fi hotspot service, or define and/or change the pairing information, among other things.

In some other embodiments, the media capturing device 710 can obtain the pairing information from the mobile computing device 720 via a short range wireless pairing there between. For instance, the media capturing device 710 can enter a Bluetooth pairing mode in response to turning on the media capturing device 710 or in response to a predefined set of button presses on the media capturing device 710. Similarly, the mobile computing device 720 can enter a Bluetooth pairing mode via its operating system services or via an application of the mobile computing device 720, such as one that may be associated with the media capturing device 710, that can employ operating system services to enter the Bluetooth pairing mode. To this end, the media capturing device 710 can wirelessly receive, via the short range wireless connection with the mobile computing device 720, the pairing information that can be utilized to connect to the Wi-Fi hotspot service or the access point. As discussed above, it is contemplated that an application of the mobile computing device 720, such as one that may be associated with the media capturing device 710, can activate and/or deactivate the Wi-Fi hotspot service or define and/or change the pairing information, among other things.

In various embodiments, the media capturing device 710 is associated with a unique identifier, such as a unique serial number, a MAC identifier, a code name, or the like. In a preferred embodiment, the unique identifier associated with the media capturing device 710 is communicated or otherwise received by the mobile computing device 720. In embodiments where the media capturing device 710 is wirelessly paired with the mobile computing device 720 (for example, via a Bluetooth connection), it is contemplated that the unique identifier can be wirelessly communicated from the media capturing device 710 to the mobile computing device 720 via the short range wireless pairing there between. In embodiments where no short range wireless pairing is available, it is contemplated that the unique identifier can be manually entered (for example, via a keyboard), or otherwise input by other means, into the mobile computing device 720 so that the unique identifier of the media capturing device 710 is stored or otherwise received by the mobile computing device 720. It is also contemplated that an ability to receive and store the unique identifier of the media capturing device 710 is facilitated by the application associated with the media capturing device 710 executing on the mobile computing device 720.

In various embodiments, after the Wi-Fi hotspot service or the access point pairing information is provided to the media capturing device 710, and the unique identifier is provided to the mobile computing device 720, the media capturing device 710 can connect to the access point or the Wi-Fi hotspot service of the mobile computing device 720 to access the network 730. In some embodiments, after an exchange of the pairing information and the unique identifier between the media capturing device 710 and the mobile computing device 720 is completed, the short range wireless pairing between the media capturing device 710 and the mobile computing device 720 can be terminated. That is, in some embodiments, the Bluetooth connection between the media capturing device 710 and the mobile computing device 720 is no longer necessary and can be deactivated. After the unique identifier of the media capturing device 710 is provided to the mobile computing device 720, and the pairing information of the mobile computing device 720 is provided to the media capturing device 710, the mobile computing device 720 can establish connectivity to the network 730 via its carrier service, and the media capturing device 710 can establish connectivity to the network 730 via the Wi-Fi hotspot service of the mobile computing device 720.

In some embodiments, in response to establishing connectivity to the network 730, the media capturing device 710 can contact a remote streaming server 740 via the network 730. The remote streaming server 740 can include one or more computing devices as described in accordance with the computing device 800 of FIG. 8 and can host or otherwise facilitate creation of a live stream of media data (for example, video data, audio data) captured by the media capturing device 710 and accessible via the network 730. In some embodiments, the remote streaming server 740 can generate a uniform resource locator (URL) to the live stream, whereby the URL is uniquely associated with the unique identifier of the media capturing device 710. The remote streaming server 740, in some instances, can limit access to the live stream by creating and/or associating access credentials to the live stream. The URL, and the access credentials (if applicable), can be shared to the mobile computing device 720 via the network 730, such that the mobile computing device 720 can access the URL and/or share the URL with other computing devices, such as computing devices 750a, 750b. While illustrated as a desktop PC, the computing devices 750a, 750b can each include one or more computing devices as described in accordance with the computing device 800 of FIG. 8.

In some embodiments, the mobile computing device 720 or other computing devices 750a, 750b can access the URL and view, on their respective displays, the media data (or a version of the media data) that is being captured by media input modules of the media capturing device 710 and streamed through the network 730 to a live stream hosted by the remote streaming server 740. In embodiments, the live stream may be initiated and accessed utilizing the media capturing device 710, which is a media capturing device that does not have an interactive user interface or display, each of which is generally known to consume a considerable amount of valuable battery power. Instead, the mobile computing device 720 may facilitate connectivity of the media capturing device 710 to the network 730 so that the live stream could be created, hosted, and accessed by other computing devices, such as the computing devices 750a, 750b. In addition, as the mobile computing device 720 is accessing the live stream via the URL, the user (or wearer) of the media capturing device 710 can utilize the mobile computing device 720 as a view finder, such that any video information that is being captured by the media capturing device 710 can be displayed on the display of the mobile computing device 720 and observed by the user. As will be described, the system 700 (or portions thereof) described herein can facilitate remote administrator features, such that a remote viewer (for example, the mobile computing device 720, other computing devices 750a, 750b) can control various features of the media capturing device 710 or modify characteristics of the media data that is being captured by the media capturing device 710 and/or streamed from the remote streaming server 740.

Having described embodiments of the present disclosure, an exemplary operating environment in which embodiments of the present disclosure may be implemented is described below in order to provide a general context for various aspects of the present disclosure. Referring to FIG. 8 in particular, an exemplary operating environment for implementing embodiments of the present disclosure is shown and designated generally as the computing device 800. The computing device 800 is one example of a suitable computing environment and is not intended to suggest any limitation as to the scope of use or functionality of the present disclosure. Neither should the computing device 800 be interpreted as having any dependency or requirement relating to any one or combination of components illustrated.

Aspects of the present disclosure may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. Aspects of the present disclosure may be practiced in a variety of system configurations, including hand-held devices, consumer electronics, general-purpose computers, more specialty computing devices, etc. Aspects of the present disclosure may also be practiced in distributed computing environments where tasks are performed by remote-processing devices that are linked through a communications network.

With reference to FIG. 8, the computing device 800 includes a bus 810 that directly or indirectly couples the following devices: a memory 812, one or more processor(s) 814, one or more presentation component(s) 816, input/output (I/O) port(s) 818, input/output components 820, an illustrative power supply 822, and radio(s) 824. The bus 810 represents what may be one or more busses (such as an address bus, a data bus, or a combination thereof). Although various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventor recognizes that such is the nature of the art and reiterates that the diagram of FIG. 8 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 8 and with reference to the term “computing device.”

The computing device 800 typically includes a variety of computer-readable media. The computer-readable media can be any available media that can be accessed by the computing device 800 and includes both volatile and nonvolatile media, and removable and non-removable media. By way of non-limiting example, the computer-readable media may comprise computer storage media and communication media. The computer storage media includes both volatile and nonvolatile, removable, and non-removable media implemented in any method or technology for storage of information, such as computer-readable instructions, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium which can be used to store the desired information and which can be accessed by the computing device 800. The computer storage media does not comprise signals per se. The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of non-limiting example, the communication media includes wired media, such as a wired network or direct-wired connection, and wireless media, such as acoustic, RF, infrared and other wireless media. Combinations of any of the above should also be included within the scope of computer-readable media.

The memory 812 includes computer-storage media in the form of volatile and/or nonvolatile memory. The memory 812 may be removable, non-removable, or a combination thereof. Exemplary hardware devices include solid-state memory, hard drives, optical-disc drives, etc. The computing device 800 includes one or more processor(s) 814 that read data from various entities such as the memory 812 or the I/O components 820. The presentation component(s) 816 present data indications to the user or other device. Exemplary presentation component(s) 816 include a display device, a speaker, a printing component, a vibrating component, etc.

The I/O port(s) 818 allow the computing device 800 to be logically coupled to other devices including the I/O components 820, some of which may be built in. Illustrative components include a microphone, a joystick, a game pad, a satellite dish, a scanner, a printer, a wireless device, etc. The I/O components 820 may provide a natural user interface (NUI) that processes air gestures, voice, or other physiological inputs generated by the user. In some instances, inputs may be transmitted to an appropriate network element for further processing. The NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion. An output of the accelerometers or the gyroscopes may be provided to the display of the computing device 800 to render immersive augmented reality or virtual reality.

As can be understood, embodiments of the present disclosure provide for, among other things, hosting a plurality of copies of a digital content. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that the present disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A head-mounted base, comprising:
a rear frame portion;
one or more side frame portions, comprising:
a power port module, and
one or more alignment portions, comprising:
a module adapted to be communicatively connected to an auxiliary display system when the auxiliary display system is releasably attached to the head-mounted base; and
a camera that is attachable to the one or more side frame portion.

2. The head-mounted base of claim 1, wherein the rear frame portion and the one or more side frame portions are comprised of a continuous portion.

3. The head-mounted base of claim 1, wherein the one or more alignment portions comprise one or more magnets coupled to the one or more side frame portions.

4. The head-mounted base of claim 1, wherein the module adapted to be communicatively connected establishes a wireless connection between the auxiliary display system and the head-mounted base when the auxiliary display system is releasably attached to the head-mounted base.

5. The head-mounted base of claim 4, wherein the wireless connection is a wireless high-definition multimedia interface.

6. The head-mounted base of claim 1, wherein the module adapted to be communicatively connected establishes a wired connection between the auxiliary display system and the head-mounted base when the auxiliary display system is releasably attached to the head-mounted base.

7. The head-mounted base of claim 6, wherein the wired connection uses a high-definition multimedia wired connection.

8. The head-mounted base of claim 3, wherein the module adapted to be communicatively connected establishes a wireless connection between the auxiliary display system and the head-mounted base when the auxiliary display system is releasably attached to the head-mounted base using the one or more alignment portions.

9. An auxiliary display system, comprising:
a lens frame portion;
one or more arm frame portions, comprising:
an auxiliary power port module, and
one or more alignment portions, comprising:
a module adapted to be communicatively connected to a head-mounted base when the auxiliary display system is releasably attached to the head-mounted base; and
a display module that is attachable to the lens frame portion.

10. The auxiliary display system of claim 9, wherein the one or more alignment portions comprise one or more magnets coupled to the one or more arm frame portions.

11. The auxiliary display system of claim 9, wherein the module adapted to be communicatively connected establishes a wireless connection between the auxiliary display system and the head-mounted base when the auxiliary display system is releasably attached to the head-mounted base.

12. The auxiliary display system of claim 11, wherein the wireless connection is a wireless high-definition multimedia interface.

13. The auxiliary display system of claim 9, wherein the module adapted to be communicatively connected establishes a wired connection between the auxiliary display system and the head-mounted base when the auxiliary display system is releasably attached to the head-mounted base.

14. The auxiliary display system of claim 13, wherein the wired connection uses a high-definition multimedia wired connection.

15. The auxiliary display system of claim 10, wherein the module adapted to be communicatively connected establishes the wireless connection between the auxiliary display system and the head-mounted base when the auxiliary display system is releasably attached to the head-mounted base using the one or more alignment portions.

16. A head-mounted display system, comprising:
a modular auxiliary display system, comprising:
a lens frame portion;
one or more arm frame portions, comprising:
an auxiliary power port module, and
one or more auxiliary alignment portions, comprising:
an auxiliary module adapted to be communicatively connected to a modular head-mounted base system; and
a display module that is attachable to the lens frame portion;
the modular head-mounted base system, comprising:
a rear frame portion;
one or more side frame portions, comprising:
a power port module, and
one or more base alignment portions, comprising:
a head-mounted module adapted to be communicatively connected to the modular auxiliary display system; and
a camera that is attachable to the one or more side frame portion.

17. The head-mounted display system of claim 16, wherein the one or more base alignment portions and the one or more auxiliary alignment portions comprises one or more magnets.

18. The head-mounted display system of claim 16, wherein the auxiliary module adapted to be communicatively connected establishes a wireless connection between the modular auxiliary display system and the modular head-mounted base system when the modular auxiliary display system is releasably attached to the modular head-mounted base system.

19. The head-mounted display system of claim 18, wherein the wireless connection is a wireless high-definition multimedia interface.

20. The head-mounted display system of claim 16, wherein the auxiliary module adapted to be communicatively connected establishes a wired connection between the modular auxiliary display system and the modular head-mounted base system when connected.
